(19) United States
(12) Patent Application Publication
(10) Pub. No.: US 2011/0176797 A1
(43) Pub. Date: Jul. 21, 2011

(54) Photographic and Projection Device

(75) Inventor: TSUNG-YI LU, Tao-Yuan (TW)

(73) Assignee: ABILITY ENTERPRISE CO., LTD., TAIPEI (TW)

(21) Appl. No.: 12/723,053

(22) Filed: Mar. 12, 2010

(30) Foreign Application Priority Data
Jan. 18, 2010 (TW) 099101283

(51) Int. Cl. G03B 19/00

(52) U.S. Cl. 396/430

(57) ABSTRACT

A photographic and projection device includes an image sensor, a lens assembly, a movable reflective mirror, and a display panel. The movable mirror has a reflective surface, and the movable mirror is disposed between the lens assembly and the image sensor. The display panel is located towards the reflective surface of the movable reflective mirror. When the movable mirror is located in a first position an external image can be formed on the image sensor by the lens assembly, and when the movable mirror is located in a second position the image of the display panel can be projected to the outside by the movable mirror and the lens assembly.

### CROSS-REFERENCE TO RELATED APPLICATIONS

The entire contents of Taiwan Patent Application No. 099101283, filed on January 18, 2010, from which this application claims priority, are incorporated herein by reference.

### BACKGROUND OF THE INVENTION

1. Field of the Invention

The present invention generally relates to a photographic device, and more particularly to a photographic and projection device.

2. Description of Related Art

Portable electronic products, such as multi-media mobile phones, mobile TV, digital cameras, digital video cameras, electronic game players, and mobile multi-media players, have become more and more popular with the common consumer in pervasive and even profound ways. The consumer has grown accustomed to watching multi-media data on portable electronic products. However, screen sizes of these portable electronic products tend to be so small as to make watching of multi-media data for a long period of time difficult. To the extent a consumer may choose to view the multi-media data on a larger screen such as that of a conventional projector, this device, too, has many deficiencies. The volume of the conventional projector, for example, is too large to allow the device to be portable. Additionally, the light source of a conventional projector generates a large amount of heat. Moreover, the cooling fan of a conventional projector, in fulfilling its function to dissipate the heating problem, generates unacceptably high levels of noise.

For the reason that there are some disadvantages of the prior art as mentioned, a need exists to propose a photographic and projection device so as to meet consumer needs.

### SUMMARY OF THE INVENTION

Accordingly, the present invention has been made in order to meet such a need as described above, it being an object of the present invention to provide a photographic and projection device so as to meet consumer needs.

In order to achieve the object, the present invention provides a photographic and projection device. The photographic and projection device includes an image sensor, a lens assembly, a movable reflective mirror, and a display panel. The movable mirror has a reflective surface, and the movable mirror is disposed between the lens assembly and the image sensor. The display panel is located towards the reflective surface of the movable reflective mirror. When the movable mirror is located in a first position an external image can be formed on the image sensor by the lens assembly, and when the movable mirror is located in a second position the image of the display panel can be projected to the outside by the movable mirror and the lens assembly.

### BRIEF DESCRIPTION OF THE DRAWINGS

FIG. 1 is a perspective view of a photographic and projection device in accordance with an embodiment of the present invention; and

FIG. 2A and FIG. 2B show different operation methods of the photographic and projection device.

### DETAILED DESCRIPTION OF THE INVENTION

A detailed description of the present invention will be discussed in connection with the following embodiments, which are not intended to limit the scope of the present invention and which can be adapted for other applications. While the drawings are illustrated in detail, it is to be appreciated that the quantity of the disclosed components may be greater or less than that disclosed except for instances expressly restricting the amount of the components.

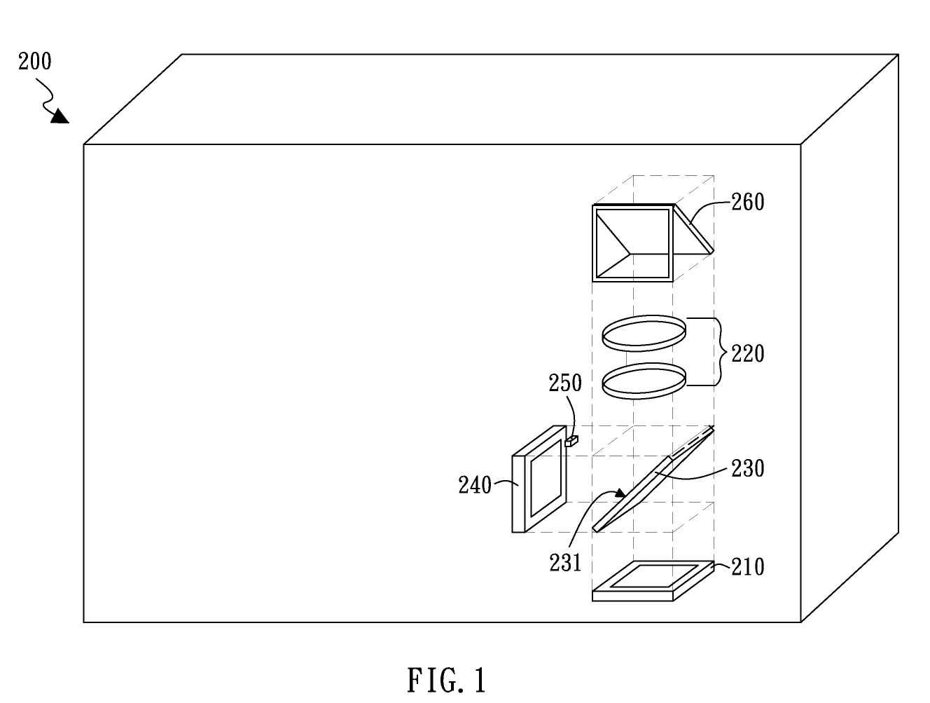

FIG. 1 provides a perspective view of a photographic and projection device 200 in accordance with an embodiment of the present invention. The photographic and projection device 200 includes an image sensor 210, a lens assembly 220, a movable reflective mirror 230, and a display panel 240.

The lens assembly 220 is disposed over the image sensor 210, and the lens assembly 220 includes at least one lens for optic operations, such as focusing, zoom-in, zoom-out, and so on. The movable mirror 230 has a reflective surface 231, and the movable mirror 230 is disposed between the lens assembly 220 and the image sensor 210. The display panel 240 is located towards the reflective surface 231 of the movable reflective mirror 230.

The reflective surface 231 of the movable reflective mirror 230 is capable of changing the path of light, and the movable reflective mirror 230 is capable of changing position among a plurality of positions. For example, the movable reflective mirror 230 is capable of changing position between a first position and a second position so as to change the path of light. For instance, when the movable mirror 230 is located in the first position an external image can be formed on the image sensor 210 by the lens assembly 220, and when the movable mirror 230 is located in the second position the image of the display panel 240 can be projected to the outside by the movable mirror 230 and the lens assembly 220.

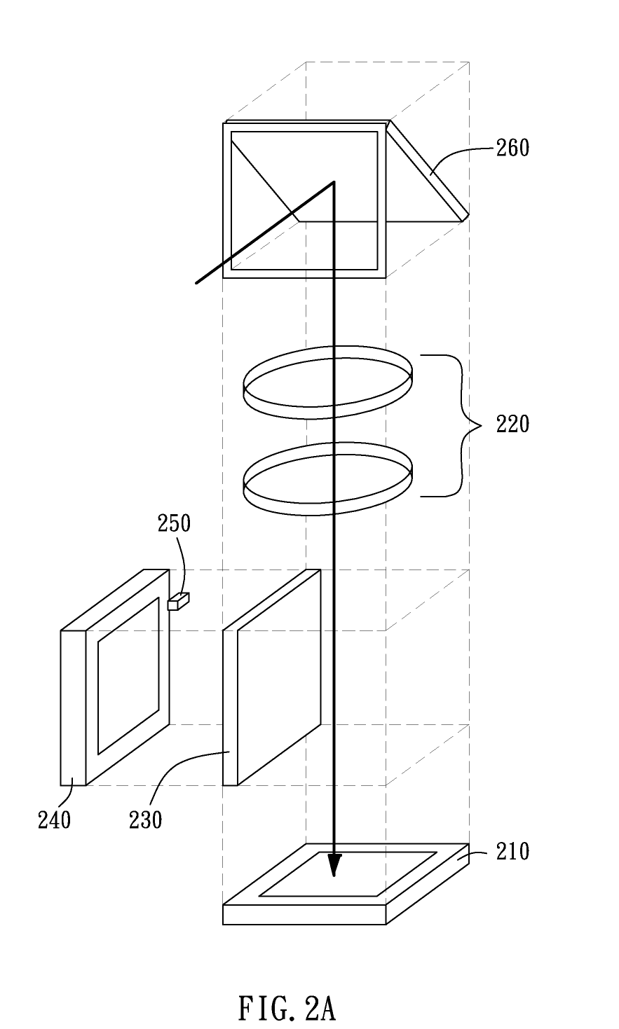

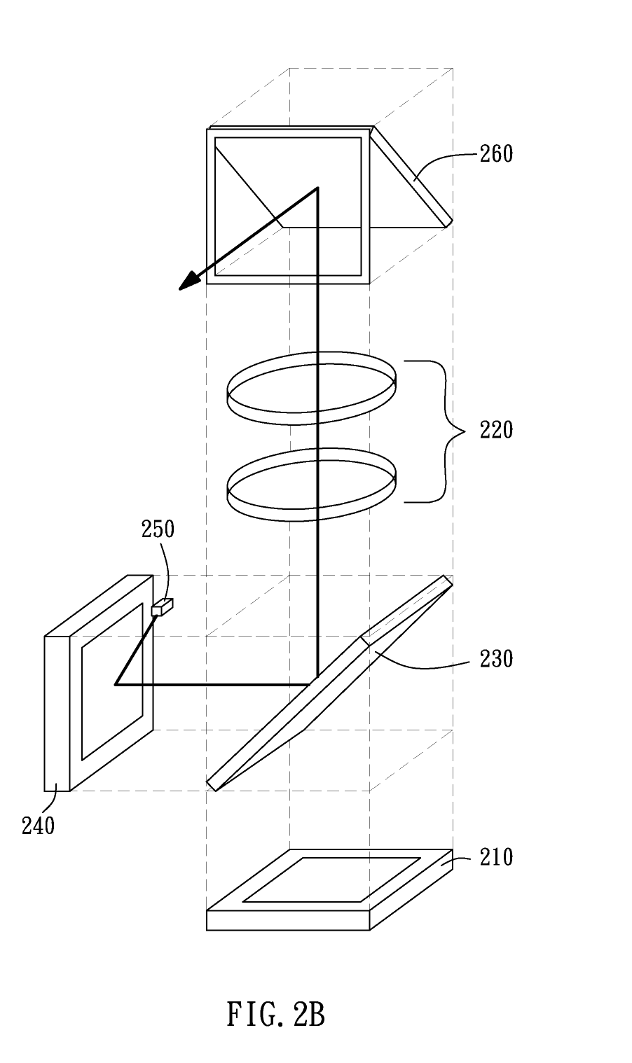

FIG. 2A and FIG. 2B show, respectively, two different operation methods of the photographic and projection device 200. Referring to FIG. 2A, one operation method comprises the movable mirror 230 being located in the first position whereby the movable mirror 230 will not interfere with the external light which is projected to the image sensor 210. Therefore, the external image can be formed on the image sensor 210 by the lens assembly 220 for capturing images.

Moreover, with reference to FIG. 2B, another operation method comprises the movable mirror 230 being located in the second position whereby the external light cannot be projected to the image sensor 210, and the image of the display panel 240 can be projected to the outside by the movable mirror 230 and the lens assembly 220.

In this embodiment, the movable mirror 230 changes position between the first position and the second position by rotation, with the arrangement being provided by way of illustration rather than restriction such that the present invention should not be limited to this. The movable mirror 230 can also change position between the first position and the second position by movement. Moreover, in this embodiment, the image sensor 210 is a CCD image sensor, but again the invention should not be limited to this. The image sensor 210 can comprise other kinds of image sensors.

In the current embodiment, the display panel 240 is a LCD panel, wherein the LCD panel is preferably a reflection-type LCD panel. The reflection-type LCD panel has at least one light source 250, wherein the light source 250 is preferably a LED light source for reducing a volume occupied by the light source 250 and decreasing an amount of heat generated by the light source 250. Although specific details of the display panel 240 have been illustrated and described in the embodiment mentioned above, the design of the display panel 240 is not to be so limited. Based on different needs, the display panel 240 can comprise other kinds of image display devices or other designs.

According to this embodiment, the photographic and projection device 200 can further include a fixed reflective mirror 260. The fixed reflective mirror 260 is disposed between the lens assembly 220 and the outside. The optic operations, such as focusing, zoom-in, and zoom-out, can be performed within the photographic and projection device 200 so as to prevent affecting the industry design of the photographic and projection device 200. Hence, the photographic and projection device 200 can comprise a compact digital camera with folding optics, but is not limited to this. Based on different needs, the photographic and projection device 200 can comprise other industry designs or other structural designs. For example, the photographic and projection device 200 can be a SLR-type digital camera, or the photographic and projection device 200 can be integrated into a photographic and projection module. The photographic and projection module can be applied in a SLR-type digital camera, a compact digital camera with folding optics, mobile phone, PDA, notebook computer, and so on.

The photographic and projection device 200 of the present invention can address, meet, or, preferably, totally meet all consumer needs. For example, there is no need for the consumer to carry a photographic device and a projection device. By the photographic and projection device 200 of the present invention, the consumer can watch large-sized images much more comfortably, rather than small-sized images. Besides, the conventional projector has many deficiencies. The conventional projector has a large volume, such that the conventional projector is not suitable to carry. The conventional projector generates large amounts of heat and noise. The photographic and projection device 200 of the present invention does not exhibit the deficiencies of conventional projectors as mentioned above. Moreover, by using the same lens assembly during capturing images and projecting images, the design of the photographic and projection device is simplified, and the volume of the photographic and projection device is decreased. The light source 250 of the display panel 240 is far from the image sensor 210. Therefore, the life-time of the image sensor 210 will not be affected by the heat generated by the light source 250.

Although specific embodiments have been illustrated and described, it will be appreciated by those skilled in the art that various modifications may be made without departing from the scope of the present invention, which is intended to be limited solely by the appended claims.

What is claimed is:

1. A photographic and projection device, comprising:
an image sensor;
a lens assembly, said lens assembly comprising at least one lens;
a movable reflective mirror, said movable mirror having a reflective surface, said movable mirror being disposed between said lens assembly and said image sensor, wherein said movable mirror is capable of changing position between a first position and a second position; and
a display panel, said display panel being located towards said reflective surface of said movable reflective mirror, wherein when said movable mirror is located in said first position an external image can be formed on said image sensor by said lens assembly, and when said movable mirror is located in said second position the image of said display panel can be projected to the outside by said movable mirror and said lens assembly.

2. The photographic and projection device according to claim 1, wherein said movable mirror changes position between said first position and said second position by rotation.

3. The photographic and projection device according to claim 1, wherein said movable mirror changes position between said first position and said second position by movement.

4. The photographic and projection device according to claim 1, wherein said image sensor comprises a CCD image sensor.

5. The photographic and projection device according to claim 1, wherein said display panel is a LCD panel.

6. The photographic and projection device according to claim 5, wherein said LCD panel is a reflection-type LCD panel.

7. The photographic and projection device according to claim 6, wherein said reflection-type LCD panel has at least one light source.

8. The photographic and projection device according to claim 7, wherein said light source is a LED light source.

9. The photographic and projection device according to claim 1, wherein said photographic and projection device is a compact digital camera with folding optics.

10. A photographic and projection module, comprising:
an image sensor;
a lens assembly, said lens assembly comprising at least one lens;
a movable reflective mirror, said movable mirror having a reflective surface, said movable mirror being disposed between said lens assembly and said image sensor, wherein said movable mirror is capable of changing position between a first position and a second position; and
a display panel, said display panel being located towards said reflective surface of said movable reflective mirror, wherein when said movable mirror is located in said first position an external image can be formed on said image sensor by said lens assembly, and when said movable mirror is located in said second position the image of said display panel can be projected to the outside by said movable mirror and said lens assembly.

11. The photographic and projection module according to claim 10, wherein said movable mirror changes position between said first position and said second position by rotation.

12. The photographic and projection module according to claim 10, wherein said movable mirror changes position between said first position and said second position by movement.

13. The photographic and projection module according to claim 10, wherein said image sensor comprises a CCD image sensor.

14. The photographic and projection module according to claim 10, wherein said display panel is a LCD panel.

15. The photographic and projection module according to claim 14, wherein said LCD panel is a reflection-type LCD panel.

16. The photographic and projection module according to claim 15, wherein said reflection-type LCD panel has at least one light source.

17. The photographic and projection module according to claim 16, wherein said light source is a LED light source.

18. The photographic and projection module according to claim 10, wherein said photographic and projection device is applied in a compact digital camera with folding optics.
